(19) United States
(12) Patent Application Publication
(10) Pub. No.: US 2026/0239072 A1
(43) Pub. Date: Aug. 13, 2026

(54) METHODS FOR LAYER 1/LAYER 2 TRIGGERED MOBILITY EXECUTION ENHANCEMENTS IN WIRELESS SYSTEMS

(71) Applicant: InterDigital Patent Holdings, Inc., Wilmington, DE (US)

(72) Inventors: Filipe CONCEICAO, London (GB); Brian MARTIN, Farnham (GB); Alain MOURAD, Ascot (GB); Milind KULKARNI, Hawthorn Woods, IL (US); Ognen OGNENOSKI, London (GB)

(73) Assignee: InterDigital Patent Holdings, Inc., Wilmington, DE (US)

(21) Appl. No.: 19/156,133

(22) PCT Filed: Feb. 22, 2024
(86) PCT No.: PCT/US2024/016805

§ 371 Date: Aug. 13, 2025

Related U.S. Application Data
(60) Provisional application No. 63/447,463, filed on Feb. 22, 2023.

(51) Int. Cl. H04W 24/10; H04B 7/06

(52) U.S. Cl. CPC H04W 24/10; H04B 7/0626

(57) ABSTRACT

A wireless transmit/receive unit (WTRU) may receive an indication indicating one or more criteria for best target cell selection amongst more than one cell. In an example, the criteria may include at least one of: a current layer 1 (L1) measurement value criterion and at least one predicted L1 measurement value criterion. The WTRU may determine a best target cell based on the criteria, and a determination of both a current L1 measurement value and at least one predicted L1 measurement value. Further, the WTRU may trigger a cell switch to the determined best target cell, based on the determination of the best target cell. Moreover, the WTRU may transmit a feedback indication containing at least one of: a measured radio metric value at a time of the cell switch, and a predicted radio metric value at the end of a prediction time span.

### CROSS-REFERENCE TO RELATED APPLICATION

This application claims the benefit of U.S. Provisional Application No. 63/447,463, filed Feb. 22, 2023, the contents of which are incorporated herein by reference.

### BACKGROUND

In wireless communication, a wireless transmit/receive unit (WTRU) may enter multiple states. These states may be termed radio resource control (RRC) states. One state is an RRC_CONNECTED state. In an RRC_CONNECTED state, the WTRU measures at least one of multiple beams of a cell and the measurement results, such as power values, are averaged to derive the cell quality. In doing so, the WTRU is configured to consider a subset of the detected beams.

Filtering takes place at two different levels: at the physical layer to derive beam quality and then at RRC level to derive cell quality from multiple beams. Cell quality from beam measurements is derived in the same way for the one or more serving cells and for the one or more non-serving cells. Measurement reports may contain the measurement results of the X best beams if the WTRU is configured to do so by a base station, such as a gNode B (gNB).

### SUMMARY

A wireless transmit/receive unit (WTRU) may receive an indication indicating one or more criteria for best target cell selection amongst more than one cell. In an example, the criteria may include at least one of: a current layer 1 (L1) measurement value criterion and at least one predicted L1 measurement value criterion. The WTRU may determine a best target cell based on the criteria, and a determination of both a current L1 measurement value and at least one predicted L1 measurement value. Further, the WTRU may trigger a cell switch to the determined best target cell, based on the determination of the best target cell. Moreover, the WTRU may transmit a feedback indication containing at least one of: a measured radio metric value at a time of the cell switch, and a predicted radio metric value at the end of a prediction time span.

In addition, the criteria may further include at least one of the prediction time span and a confidence level. In another example, the criteria may further include one or more previously configured criteria. In an additional example, the received indication may be received via a medium access control (MAC) control element (CE).

Additionally, the WTRU may receive a configuration with a set of one or more L1/layer 2 (L2) triggered mobility (LTM) candidate cells. In an example, the configuration may include an associated predictive measurement configuration per candidate cell for one or more: one or more measurement metrics, one or more L1 prediction triggers, the prediction time span, procedure validity, or a reporting criterion. The configuration may be received via radio resource control (RRC) signaling, in an example. In another example, the one or more L1 prediction triggers may include one or more of time measurement value or radio measurement values. In a further example, the procedure validity may include one or more of an inference periodicity, a moving window, or a one-time procedure.

Also, triggering the cell switch may include one or more of an early uplink (UL) synchronization, an early downlink (DL) synchronization, or triggering channel state information (CSI) measurement and reporting, in an example. In a further example, the WTRU may predict one or more future L1 measurements for one or more cells in set of one or more LTM candidate cells, covering the prediction time span. Moreover, the WTRU may transmit a measurement report to a base station, wherein the report includes current L1 measurements and predicted L1 measurements for at least one cell in the set of one or more LTM candidate cells.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a high level diagram illustrating an example of a beam measurement model including measurement reporting;

FIG. 3 is an operation diagram illustrating an example of layer 1 (L1)/layer 2 (L2) triggered mobility (LTM) using carrier aggregation (CA).

FIG. 4 is a signaling diagram illustrating an example of current LTM signaling procedure;

FIG. 5 is a signaling diagram illustrating an example of a baseline LTM signaling procedure.

FIG. 6 is a diagram illustrating an example of a time series prediction for reference signal received power (RSRP);

FIG. 7 is a timeline diagram illustrating an example of a one-time inference procedure window;

FIG. 8 is a timeline diagram illustrating an example of periodic WTRU predictions with window re-use;

FIG. 9 is a timeline diagram illustrating an example of a WTRU moving window inference procedure with spacing and window re-use;

FIG. 10 is a timeline diagram illustrating an example of periodic WTRU predictions with configured window settings;

FIG. 11 is a timeline diagram illustrating an example of a WTRU moving window inference procedure with configurable spacing and window;

FIG. 12 is a flow chart diagram illustrating an example of a WTRU selecting the best target cell based on current and predicted values;

FIG. 13 is a flow chart diagram illustrating an example of a WTRU switching cells to a fallback cell based on predicted radio measurements; and

FIG. 14 is a flow chart diagram illustrating an example of a WTRU reducing the size of a candidate cell set to monitor.

### DETAILED DESCRIPTION

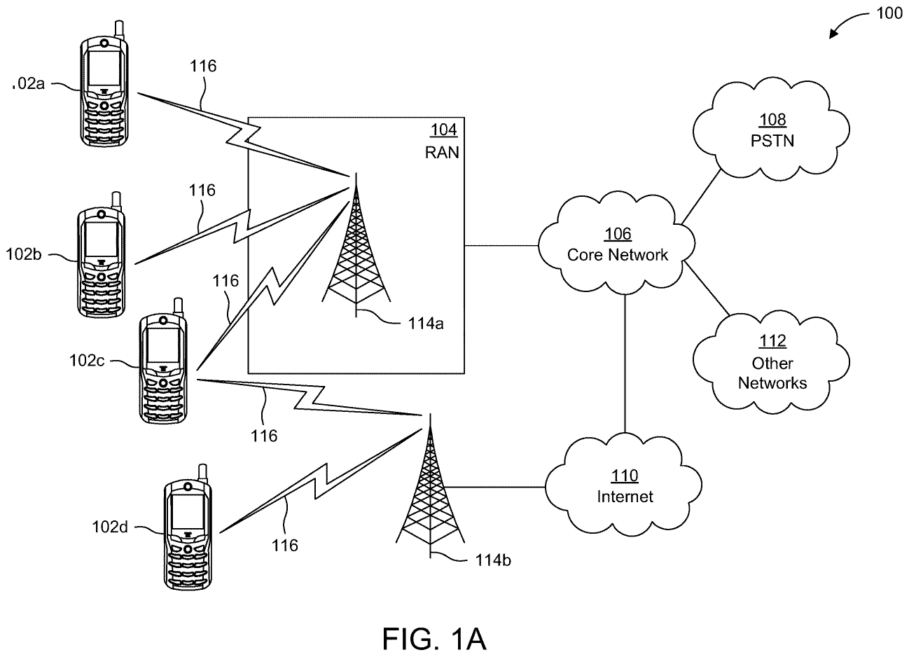

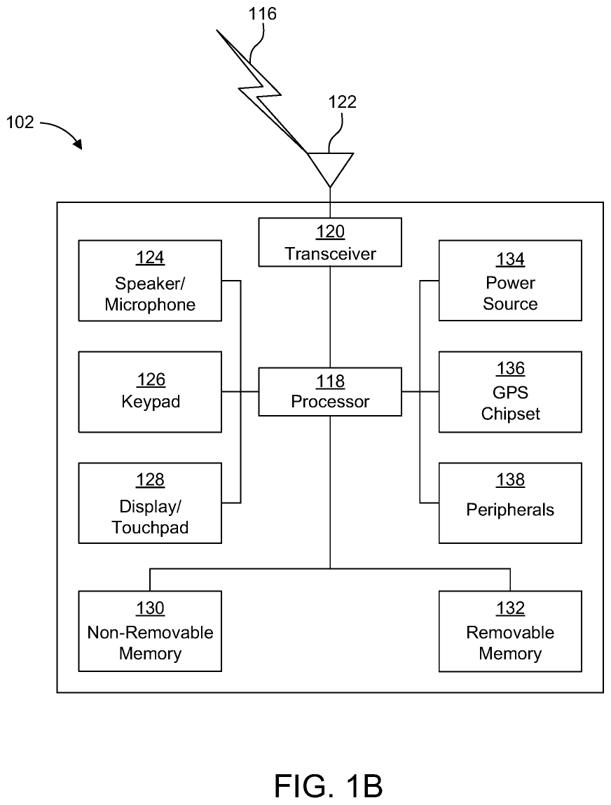

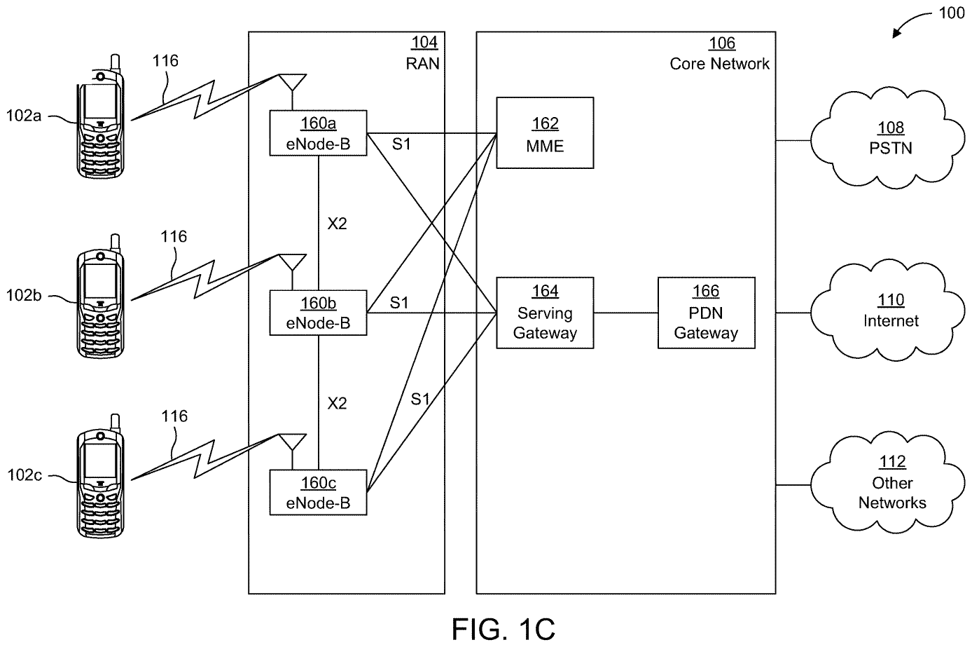

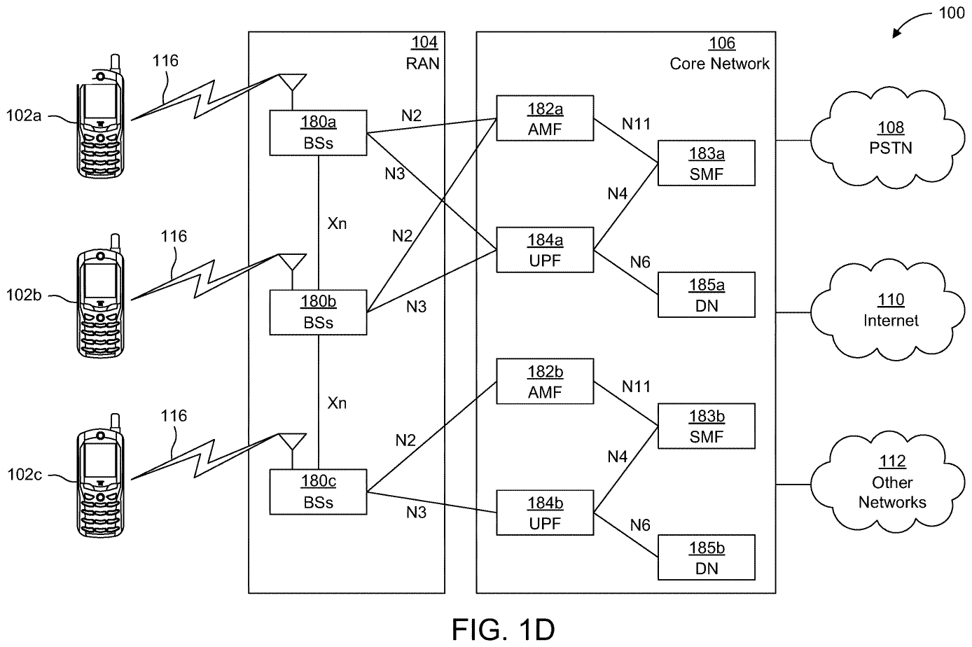

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

In an RRC_CONNECTED state, the WTRU measures at least one of multiple beams of a cell and the measurement results, such as power values, are averaged to derive the cell quality. In doing so, the WTRU is configured to consider a subset of the detected beams. Filtering takes place at two different levels: at the physical layer to derive beam quality and then at the radio resource control (RRC) level to derive cell quality from multiple beams. Cell quality from beam measurements is derived in the same way for the one or more serving cells and for the one or more non-serving cells.

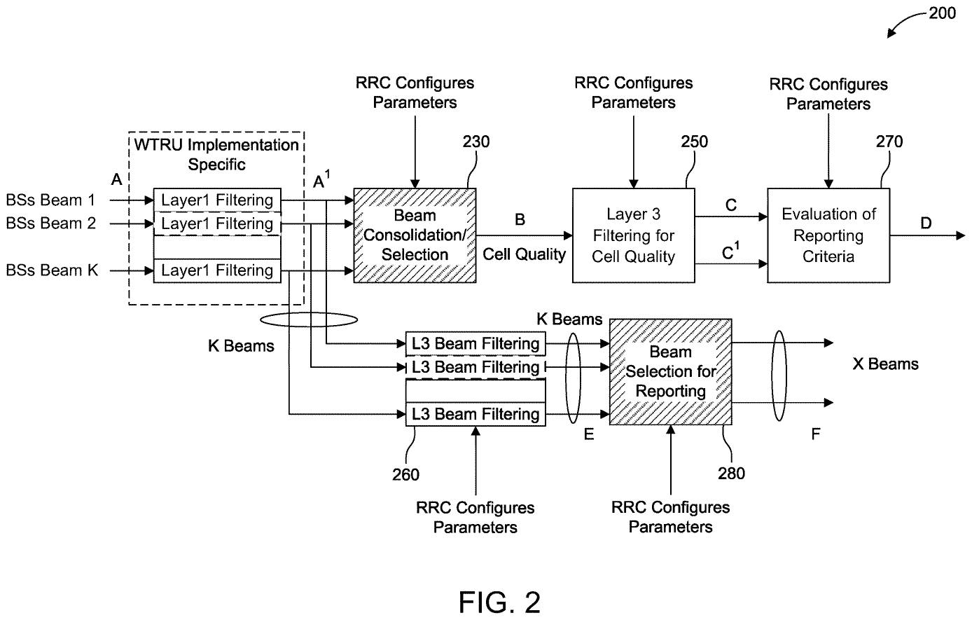

FIG. 2 is a high level diagram illustrating an example of a beam measurement model including measurement reporting. As shown in an example in high level diagram 200, measurement reports may contain the measurement results of the X best beams if the WTRU is configured to do so by the base station, such as a gNB.

Further, the beam measurement model may include beam consolidation, beam selection, or both 230. In addition, the model may include layer 3 (L3) filtering for cell quality 250 and evaluation of reporting criteria 270. Moreover, the model may include L3 beam filtering for K beams 260 and then beam selection for beam reporting 280 for X best beams, which may be best beams.

Examples herein include inter-cell layer 1 (L1)/layer 2 (L2) triggered mobility (LTM). Current wireless communication may use inter-cell beam management which can manage the beams in a carrier aggregation (CA) case, but no cell change and no cell addition is currently supported. In a modification, L1/L2 based inter-cell mobility may be used for mobility latency reduction.

Specific mechanisms and procedures of L1/L2 based inter-cell mobility for mobility latency reduction may include any one or any combination of the following. The mechanisms may include configuration and maintenance for multiple candidate cells to allow fast application of configurations for candidate cells. Also, the mechanisms may include a dynamic switch mechanism among candidate serving cells, including a special cell (SpCell) and a secondary cell (SCell), for the potential applicable scenarios based on L1/L2 signaling. Further, mechanisms may include L1 enhancements for inter-cell beam management, including L1 measurement and reporting, and beam indication. Moreover, mechanisms may include timing advance management. Additionally, mechanisms may include centralized unit (CU)-distributed unit (DU) interface signaling to support L1/L2 mobility, if needed.

Procedures of L1/L2 based inter-cell mobility are applicable to the following scenarios: standalone, CA and NR-DC case with serving cell change within one cell group (CG); intra-DC case and intra-CU inter-DU case, applicable for standalone and CA, with no new RAN interfaces applicable; both intra-frequency and inter-frequency cases; both frequency range 1 (FR1) and frequency range 2 (FR2) cases; source and target cells may be synchronized or non-synchronized; and an inter-CU case is not included.

L1/L2 based mobility has been used. Inter-cell beam management addresses intra-DU and intra-frequency scenarios. In this case, the serving cell remains unchanged. In other words, there is no possibility to change the serving cell using L1/2 based mobility. In FR2 deployments, CA is typically used in order to exploit the available bandwidth, for example, to aggregate multiple component carriers (CCs) in one band. These CCs are typically transmitted with the same analog beam pair, for example, a base station or gNB beam and a WTRU beam. The WTRU is configured with transmission configuration indication (TCI) states (which can have a fairly large number, for example 64) for reception of a physical downlink control channel (PDCCH) and a physical downlink shared channel (PDSCH). Each TCI state includes a reference signal (RS) or a synchronization signal block (SSB) that the WTRU refers to for setting its beam. The SSB can be associated with a non-serving physical cell identity (PCI).

MAC signaling activates the TCI state for a Coreset/PDCCH. The MAC signaling may include a TCI state indication for WTRU-specific PDCCH MAC CE. Reception of a PDCCH from a non-serving cell is supported by a MAC control element (CE) indicating a TCI state associated with a non-serving PCI.

MAC signaling activates a subset of (up to) 8 TCI states for PDSCH reception. The MAC signaling may include TCI States Activation/Deactivation for WTRU-specific PDSCH. Downlink control information (DCI) indicates which of the 8 TCI states to use. Current wireless communication also supports “unified TCI state” with a different updating mechanism (DCI-based), but without multi-transmission/reception point (TRP) operation. Modified wireless communication will support unified TCI state with multi-TRP operation.

The overall objective of LTM is to improve handover latency; with a conventional L3 handover or conditional handover, the WTRU will typically first send a measurement report using RRC signaling. In response to this, the network may provide a further measurement configuration and potentially a conditional handover configuration. With a conventional handover, the network provides a configuration for a target cell after the WTRU reports, using RRC signaling, that the cell meets a configured radio quality criteria.

With conditional handover, in order to reduce the handover failure rate due to the delay in sending a measurement report then receiving an RRC reconfiguration the network provides, in advance, a target cell configuration as well as a measurement criteria which determines when the WTRU should trigger the conditional handover (CHO) configuration. Both of these L3 methods, however, do suffer from some amount of delay due to the sending of measurement reports and receiving of target configurations, particularly in case of the conventional (non-conditional) handover.

In particular, the aim of LTM is to allow a fast application of configurations for candidate cells, including dynamically switching between SCells and switching of the primary cell (PCell), for example, switching the roles between SCell and PCell, without performing RRC signaling. The inter-CU case is not included, as this requires relocation of the packet data convergence protocol (PDCP) anchor and has already been excluded from prior modifications. Therefore, an RRC based approach is needed at least to support inter-CU handover.

Furthermore, with the legacy L3 handover mechanisms, any currently active SCell(s) are released before the WTRU moves completes the handover to a target cell in the coverage area of a new site, and can only be added back after successful handover, which leads to throughput degradation during handover. One of the aims of L1/2 is therefore to enable CA operation to be enabled instantaneously upon serving cell change.

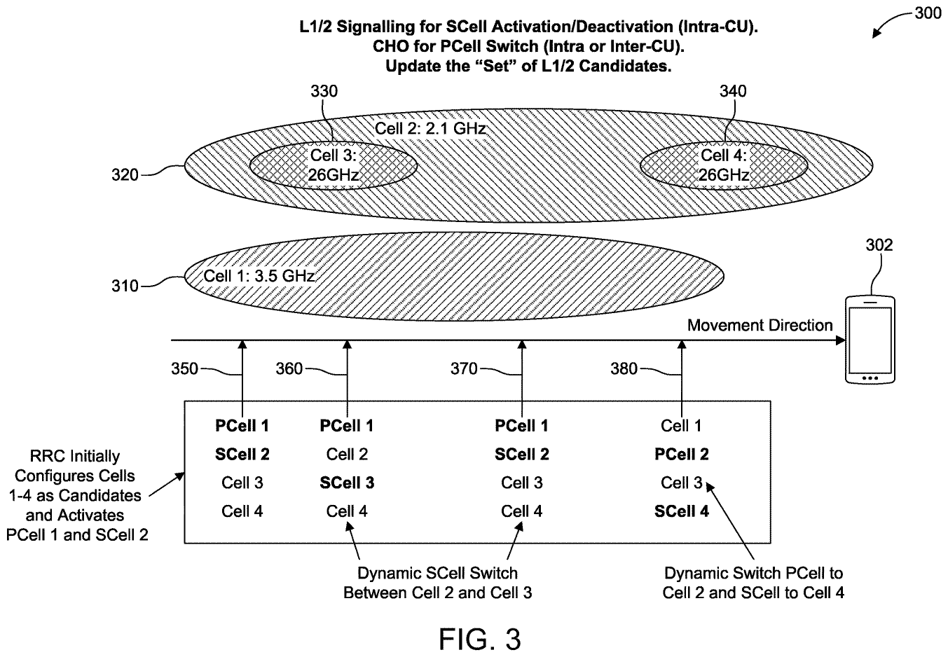

FIG. 3 is an operation diagram illustrating an example of LTM using CA. Operation diagram 300 shows an example of LTM operation, whereby the candidate cell group is configured by RRC and a dynamic switch of PCell and SCell is achieved using L1/2 signaling. Specifically, L1/2 signaling may be used for SCell activation/deactivation and/or SpCell switch.

In an example shown in FIG. 3, cell 1 may use 3.5 GHz frequency 310, cell 2 may use 2.1 GHz frequency 320, cell 3 may use 26 GHz frequency 330 and cell 4 may also use 26 GHz frequency 340. A WTRU 302 may move in a direction across the length of cell 1 310 and cell 2 320. In an example, WTRU 302 may be the same as or similar to WTRU 102.

WTRU 302 may be initially configured by way of RRC signaling with cell 1 310, cell 2 320, cell 3 330 and cell 4 340. Further, WTRU 302 may be configured by way of RRC signaling with cell 1 310 as a PCell, shown as PCell 1 and cell 2 320 as an SCell, shown as SCell 2, at a point 350 in a movement direction of WTRU 302 and in time. Then, at point 360, WTRU 302 may be configured by way of a dynamic SCell switch with cell 3 330 as an SCell, shown as SCell 3, thereby switching the SCell from cell 2 320 to cell 3 330. Cell 1 310 may remain as PCell 1. The dynamic SCell switch may be signaled to WTRU 302 by way of L1/2 signaling.

WTRU 302 may continue in its movement direction. Accordingly, at point 370, another dynamic SCell switch may be applied to WTRU 302 and WTRU 302 may be configured by way of L1/2 signaling with cell 2 320 as SCell 2, switching from cell 3 330, as shown in FIG. 3.

Further, at point 380, a dynamic PCell switch may be applied to WTRU 302 and the PCell may switch from cell 1 310 to cell 2 320, shown as PCell 2. Further, WTRU 302 may be configured with cell 4 340 as SCell 4, switching from cell 2 320. This PCell switch and SCell switch may be configured by way of L1/2 signaling.

A new mobility procedure is currently being standardized in 3GPP. The procedure aims at executing mobility procedures using resources from L1 and L2 and is named LTM.

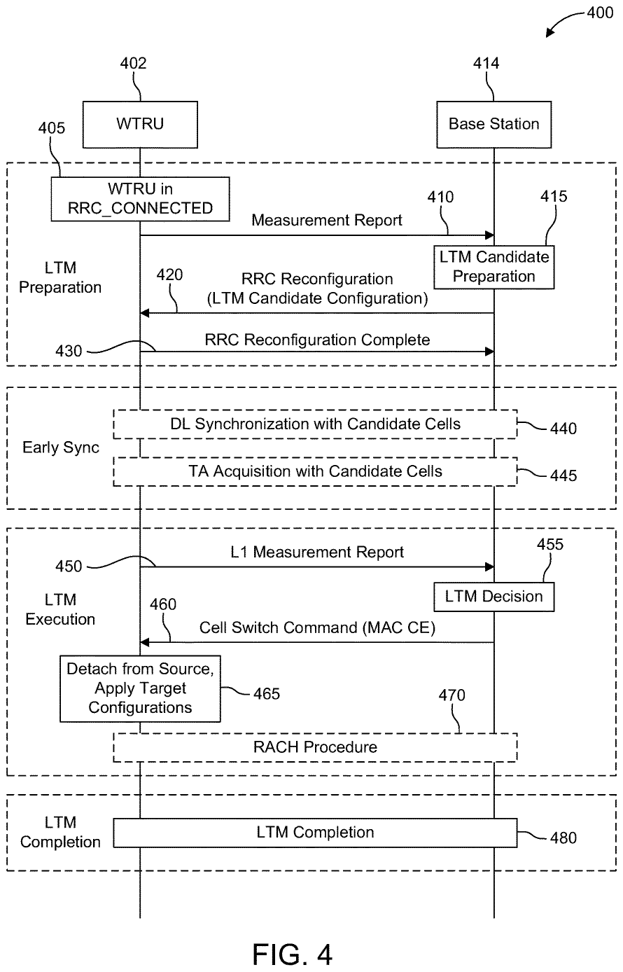

FIG. 4 is a signaling diagram illustrating an example of current LTM signaling procedure. The basics of the new LTM procedure are depicted in an example shown in signaling diagram 400, and a high level explanation of the steps follows. A goal herein is to provide the relevant information from the baseline mechanism from which further modifications and enhancements are provided elsewhere herein.

The new procedure works by activating mobility via L2 signaling, namely, via a MAC CE. The WTRU gets configured with a set of target cells with L3 signaling (LTM preparation) and then performs handover (HO) based on L2 MAC CE signaling (LTM execution), which is a faster method than L3 legacy mobility. In between the preparation and execution phases, there is a synchronization phase, which is understood by those in the art.

A procedure for LTM is as follows from an example depicted in signaling diagram 400. WTRU 402, which may be same as or similar to WTRU 102 in FIG. 1, may be in an RRC_CONNECTED state 405. The WTRU 402 sends a MeasurementReport message 410 to the gNB or base station 414. The gNB or base station 414 decides to use LTM and initiates LTM candidate preparation 415. The gNB or base station 414 transmits an RRCReconfiguration message 420 to the WTRU 402 including the configuration of one or multiple LTM candidate target cells. The WTRU 402 stores the configuration of one or more LTM candidate target cells and transmits an RRCReconfigurationComplete message 430 to the gNB or base station 414. Accordingly LTM preparation may be performed before early synchronization, LTM execution, or LTM completion

The WTRU 402 may perform DL synchronization 440 and timing advance (TA) acquisition with one or more candidate target cells before receiving the LTM cell switch command. For example, DL synchronization for one or more candidate cells 440 before switch command may be performed, at least based on an SSB. Moreover, TA acquisition of one or more candidate cells 445 before LTM cell switch command may be performed, at least based on PDCCH ordered random access channel (RACH), where the PDCCH order is only triggered by source cell. Accordingly, early synchronization may be performed before LTM execution or LTM completion.

The WTRU 502 performs L1 measurements on the one or more configured LTM candidate target cells, and transmits one or more lower-layer measurement reports 450 to the gNB or base station 414. In examples, the lower-layer measurement reports 450 may be carried on L1 or MAC signaling.

The gNB or base station 414 decides to execute LTM cell switch to a target cell 455, and transmits a MAC CE triggering LTM cell switch 460 by including indication information regarding the candidate configuration index of the target cell. The MAC CE 460 may be considered a cell switch command, in an example. The WTRU 402 switches to the configuration of the LTM candidate target cell. Accordingly, LTM execution may be performed, and the WTRU 402 may detach from its source, and apply target configurations 465. Further, a beam indication may be transmitted, in an example.

The WTRU 402 performs random access procedure 470, such as a RACH procedure, towards the target cell, if TA is not available. Also, the WTRU 402 indicates successful LTM completion 480 of the LTM cell switch towards the target cell. In an example, an uplink signal or message after the WTRU 402 has switched to the target cell may be used to indicate successful completion of the LTM cell switch.

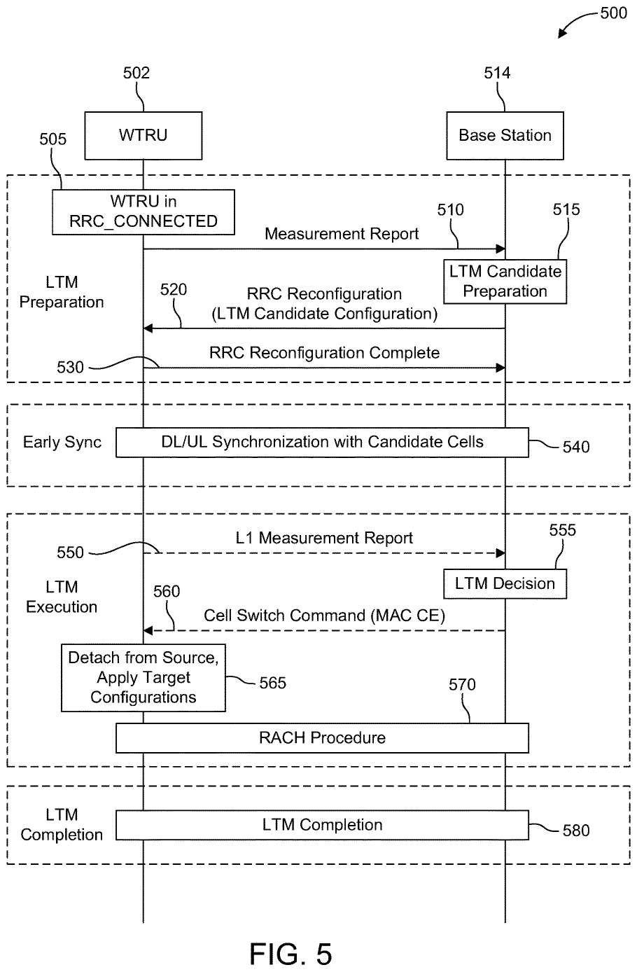

FIG. 5 is a signaling diagram illustrating an example of a baseline LTM signaling procedure. A baseline procedure for LTM is as follows from an example depicted in signaling diagram 500. WTRU 502, which may be same as or similar to WTRU 102 in FIG. 1, may be in an RRC_CONNECTED state 505. The WTRU 502 sends a MeasurementReport message 510 to the gNB or base station 514. The gNB or base station 514 decides to use LTM and initiates LTM candidate preparation 515. The gNB or base station 514 transmits an RRCReconfiguration message 520 to the WTRU 502 including the configuration of one or multiple LTM candidate target cells. The WTRU 502 stores the configuration of LTM candidate target cell(s) and transmits an RRCReconfigurationComplete message 530 to the gNB or base station 514.

The WTRU 502 may perform DL synchronization 540 and timing advance (TA) acquisition with candidate target cell(s) before receiving the LTM cell switch command. For example, DL synchronization for candidate cell(s) 540 before switch command may be performed, at least based on an SSB. Moreover, TA acquisition of candidate cell(s) before LTM cell switch command may be performed, at least based on PDCCH ordered random access channel (RACH), where the PDCCH order is only triggered by source cell. Additionally, UL synchronization 540 with candidate cell(s) may also be performed. Accordingly, early synchronization may be performed before LTM execution or LTM completion.

The WTRU 502 performs L1 measurements on the configured LTM candidate target cell(s), and transmits lower-layer measurement reports 550 to the gNB or base station 514. In examples, the lower-layer measurement reports 550 may be carried on L1 or MAC signaling.

The gNB or base station 514 decides to execute LTM cell switch to a target cell 555, and transmits a MAC CE triggering LTM cell switch 560 by including indication information regarding the candidate configuration index of the target cell. The MAC CE 560 may be considered a cell switch command, in an example. The WTRU 502 switches to the configuration of the LTM candidate target cell. Accordingly, LTM execution may be performed, and the WTRU 502 may detach from its source, and apply target configurations 565. Further, a beam indication may be transmitted, in an example.

The WTRU 502 performs random access procedure 570, such as a RACH procedure, towards the target cell, if TA is not available. Also, the WTRU 502 indicates successful LTM completion 580 of the LTM cell switch towards the target cell. In an example, an uplink signal or message after the WTRU 502 has switched to the target cell may be used to indicate successful completion of the LTM cell switch.

Currently discussed new LTM procedures do not benefit from artificial intelligence (AI)/machine learning (ML) methods. Under previously and currently discussed LTM procedures, decision making processes may not be the fastest possible, failures can occur incurring in further delays, and the WTRU may be given sub-optimal monitoring criteria. Examples solutions provided herein help address these problems.

Specifically, in the current LTM mechanism, the WTRU is configured with a candidate cell list via RRC signaling and performs cell switch upon reception of a MAC CE. The current baseline mechanism is more efficient and faster than mechanisms used before the current baseline was developed. However, once configured with a set of LTM candidates, the configured set stays the same until the WTRU executes HO. If there are changes in the configuration, L3 signaling is required, increasing signaling overhead. The WTRU may be instructed to monitor a larger set of cells than what is actually necessary. In order to choose the best target cell, the WTRU relies on network (NW) configured criteria that are radio measurement threshold based. This means the WTRU needs to wait for the one or more configured thresholds to be actually met, further delaying a process that is being designed to be faster than current L3 mobility. Finally, the current procedure does not provide any fallback options. In the event of any type of failure performing cell switch to another cell, the WTRU needs to, for example, declare radio link failure (RLF) and choose another cell, or wait for NW instructions on how to act next.

Moreover, in example cases, a cell level WTRU trajectory shall be predicted and may be exchanged between RAN nodes. The cell level prediction can be a very useful tool in the configuration of mobility processes in the WTRU. For these reasons, the following technical questions are addressed herein. How to enhance the new LTM procedure to exploit L1 measurement anticipation to make more optimal target cell selection is addressed herein. How to enhance the new LTM procedure to include a fallback mechanism in case of failures, based on L1 measurement anticipation is also addressed herein. How to enhance the new LTM procedure to exploit NW produced WTRU cell level trajectory predictions to reduce signaling is additionally addressed herein.

Embodiments and examples herein include successful LTM case enhancements, where upon reception of cell switch command, the WTRU selects the best target cell based on current and predicted values. For example, a WTRU may receive a configuration with a set of one or more LTM candidate cells (for example, via RRC signaling) where the configuration may include an associated predictive measurement configuration per candidate cell, for example, one or more of the following: one or more measurement metrics) L1 prediction triggers (for example, time or radio measurement values), prediction time span, procedure validity (for example inference periodicity, moving window, one-time procedure), or reporting criteria.

Further, the WTRU may predict/infer one or more future L1 measurements for one or more cells in the configured LTM cell set, covering the prediction time span. For example, the WTRU may predict/infer when triggered to predict/infer one or more future L1 measurements by a configured L1 prediction trigger being satisfied. Also, the WTRU may transmit a measurement report to the NW with the report containing current L1 measurements, predicted L1 measurements, or both, for at least one cell in the configured set of LTM candidate cells.

Moreover, the WTRU may receive an indication (for example, via MAC CE) with one or more criteria, or an indication to one or more previously configured criteria, for best target cell selection amongst more than one cell, where the criteria include at least one of: a current L1 measurement value; at least one predicted L1 measurement value; or a time span for predictions and/or confidence levels. The WTRU may determine the best target cell based on the received/configured criteria. Further, the WTRU may perform cell switching to the determined best target cell, based on the previous determination of both current and predicted L1 values. Accordingly, the WTRU may transmit a feedback indication containing at least one of the following: a measured radio metric value at the cell switch time, or a predicted radio metric value at the end of the prediction time span.

Embodiments and examples herein include a failure case for LTM, where the WTRU performs cell switching, upon failure, to a fallback/second cell based on predicted radio measurements for the fallback/second targets. For example, a WTRU may receive (for example, via RRC signaling) a configuration with a first cell and one or more dependent second cells, where the configuration includes at least one of the following per configured cell: one or more radio measurement thresholds, such as, for example, an L1 reference signal received power (RSRP); or L1 prediction triggers, such as, for example, time or measurement values.

Further, the WTRU may receive an indication (for example, via MAC CE) of a target cell to be designated as a first cell and one or more target cells to be designated as the one or more dependent second cells, where for each of the one or more dependent second cells, at least one of the following is included: one or more radio measurement thresholds; one or more NW-predicted L1 measurement values; a time span for the WTRU-predicted values; or one or more criteria, or indications for a previously configured one or more criteria, for an NW L1 measurement prediction assessment, where the one or more criteria includes at least one of: a threshold used for WTRU-predicted measurement values and NW-predicted measurement values, or a threshold used for WTRU-measured measurement values and NW-predicted measurement values. Additionally, the WTRU may attempt cell switching toward the first target cell. Also, the WTRU may determine a failure on the cell switch to a first target cell based on, for example, RACH failure, loss of synchronization, security establishment failure, and the like.

Moreover, the WTRU may determine a second best target dependent cell from the one or more target cells designated as one or more second cells, based on at least one of NW-predicted measurement values, WTRU-measured measurement values, and one or more indicated criteria. In addition, the WTRU may perform cell switching towards the determined second best target cell. Further, the WTRU may transmit a feedback indication containing at least one of the following: a measured radio metric value for the determined second best target cell; or a predicted radio metric value for the determined second best target cell.

Embodiments and examples herein include multi-cell monitoring management, where upon being configured with LTM candidate cell sets, the WTRU assists the NW in reducing the size of the set to monitor, based on predicted radio measurements. For example, a WTRU may receive a configuration for an LTM candidate cell group, including at least one of: one or more candidate cells; one or more measurement metric(s); a validity time; thresholds for triggering predictions (time or measurement values) for one or more cells of the configured LTM candidate cell group; or one or more criteria to determine the cells for which the WTRU is to continue monitoring. For example, the WTRU may continue monitoring a cell if a predicted measurement value is above a threshold.

Further, the WTRU may predict/infer one or more future L1 measurement values for one or more candidate cells in the configured LTM cell group. Also, the WTRU may determine a selected subset of one or more candidate cells to continue monitoring from the received configuration, based on at least a predicted L1 measurement values or a configured criterion. Also, the WTRU may transmit an indication (for example, via MAC CE) to the NW of the selected subset of one or more candidate cells, where the indication includes at least one of: a predicted L1 measurement values of the one or more cells of the selected subset; timings associated with predicted L1 measurement values; measured radio metric value for one or more cells of the first LTM candidate cell group not included in the selected subset of one or more candidate cells; or predicted radio metric value for one or more cells of the first LTM candidate cell group not included in the selected subset of one or more candidate cells.

Moreover, the WTRU may receive an indication (for example, via MAC CE) configuring a second LTM candidate cell group, including one or more criteria, or an indication of a previously configured one or more criteria, associated with each candidate cell in the second LTM candidate cell group. Also, the WTRU may determine a candidate cell of the second LTM candidate cell group for which a cell switch criteria has been met and performing cell switch to the determined candidate cell. In addition, the WTRU may transmit on resources associated with the determined candidate cell.

Embodiments and examples herein include candidate LTM cells. The one or more candidate cells may be groups of more than one RRC configuration corresponding to a handover configuration for one or more candidate SpCells and optionally SCells. This may be modelled or received as one or more complete RRC Reconfiguration messages, one or more cell group configurations, or one or more cell configurations. Each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which are used in L1 and MAC signaling to refer to specific indexes. For example, a MAC CE triggering the reconfiguration may include a candidate configuration index informing the WTRU which cell to perform the reconfiguration to.

The one or more candidate cell groups may be configured as a single list or group of candidate cell configurations at RRC. The grouping may occur at the early synchronization phase or LTM execution phase rather than the configuration phase. Accordingly, the candidate cell set may be considered as a single group in terms of an RRC configuration list or group, while the cells selected for performing early sync, L1 measurements, and LTM execution depend on a further grouping into multiple subsets of the overall candidate cell list. In other words, the grouping itself may not be modelled at RRC using candidate configuration identifiers, but the grouping may be executed as part of the early synchronization procedure or the LTM execution procedure.

Throughout the embodiments and examples provided herein, when referring to an LTM candidate configuration, this phrase may apply to any type of preconfigured cell information. For example, a WTRU may be configured with one or more conditional reconfigurations such as conditional handover (CHO), conditional PSCell addition (CPA) or conditional PSCell change (CPC) which are valid before and/or after a cell change, or valid in certain cells.

An L1 measurement, as used in embodiments and examples provided herein, may consist of a measurement of RSRP, a measurement of reference signal received quality (RSRQ), a measurement of received signal strength indicator (RSSI), and the like, performed by a WTRU of a cell, beam, set of cells, or set of beams. Such L1 measurements may be similar to L3 measurements reported in radio resource management (RRM), with differences in the filtering, reference signals measured, reporting mechanisms, and the like.

In embodiments and examples provided herein, L1 measurement can apply also to RRM reporting. Herein, measurements may refer to L1 measurements for LTM. However, certain example solutions provided herein may apply also to RRM measurements, L3 measurements, or both, as well as other measurements, such as, for example measurements of speed, location, height, traffic, and the like.

In examples provided herein, network and/or WTRU prediction capabilities may be based on AI/ML techniques. The WTRU experienced conditions today come from real measurements the WTRU performs over time. In a simple mobility scenario, a WTRU in mobility will read the current serving cell's RSRP and report it to the NW. If the WTRU is moving to an area approaching the serving cell's edge, it will record that RSRP values are decreasing. These values are communicated to the NW via measurement reports for the NW to make a decision.

For the purpose of several embodiment and examples provided herein, both the NW and the WTRU are assumed to have a pre-trained AI/ML model that is able to produce predictions of air-interface measurements, such as RSRP, RSRQ, signal-to-interference-and-noise-ratio (SINR), and the like, of serving and/or neighbor cells (or any cell in several embodiment and examples provided herein). The predictions are a tool in several embodiment and examples provided herein to anticipate the radio conditions the WTRU will experience, instead of waiting for the WTRU to report.

In order to produce more meaningful predictions in this context, it makes sense to consider that the NW predicts, for example, RSRP in a time series manner. This means that from the moment the NW predictions are triggered, the WTRU will produce several prediction outputs over a future time span, with a certain granularity or time step.

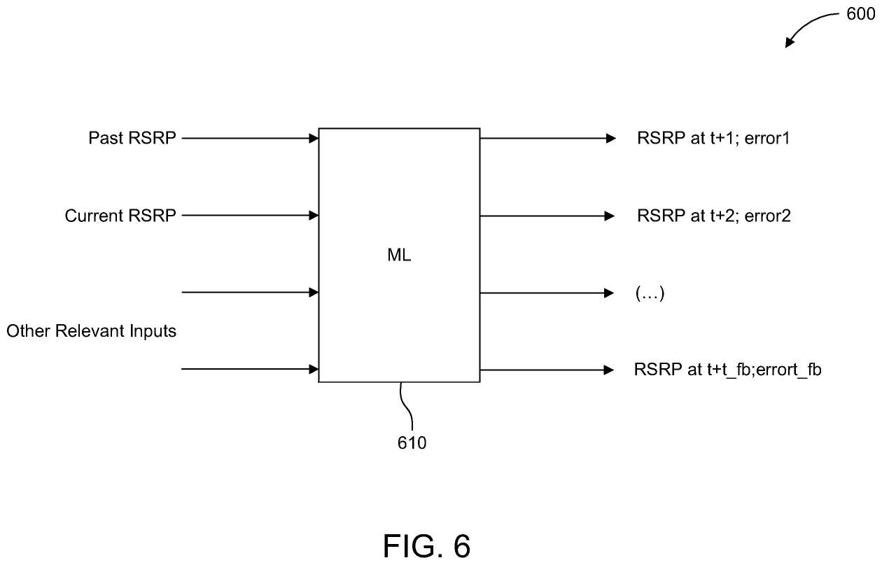

FIG. 6 is a time series diagram illustrating an example of a time series prediction for RSRP. As shown in an example in time series diagram 600, at time t, the network may predict one RSRP prediction point per time step from time t+1 until t+t_fb. The predictions can also be done for one point in time only, and can extend over several time steps. In many scenarios, prediction with time series output may be more beneficial than single value predictions, as it may be difficult to match the prediction regarding, for example, a NW configured event with a single prediction point.

These examples may include practical issues understood by those skilled in the art. The triggers for network predictions may also be understood by those skilled in the art, but a few suggestions are included herein for these two aspects, as follows.

Specifically, a WTRU may be configured to predict future measurements based on current and/or historical measurements. For example, the WTRU may be configured with a trained AI/ML model that is able to produce predictions for radio interface radio signal levels, such as ML model 610 shown in an example in FIG. 6. In an example solution, the AI/ML model at the WTRU may be implementation based. In another example solution, the AI/ML model the WTRU may obtain the AI/ML model from the NW. In one example solution, the AI/ML model may be configured to take as an input current and/or historical RSRP measurements. In another example solution, the AI/ML model may be configured to take additional inputs such as WTRU location information, WTRU mobility and the like. In one example solution, the AI/ML model may be configured to produce single value predictions. For example, the AI/ML model may produce RSRP at a future time instant t. In another example solution, the AI/ML model may be configured to predict a series of RSRP values corresponding to future time instances t+1, t+2 so on up to t+t_fb, as shown in an example in FIG. 6. A model may be trained offline, or trained online, and may be exchanged in a pre-configuration step, as may also be understood by those skilled in the art.

The proposed example solutions provided herein may rely heavily on measurement predictions. These measurement predictions can be NW generated, WTRU generated, or both. A common aspect related to many example solutions provided herein is the initial configuration step, where the WTRU may be instructed to generate predictions, such as measurement predictions.

Embodiments and examples herein vary but may also share common benefits. For example, embodiments and examples herein include fast mobility gains, such as in latency, reduced handover failure (HOF), which are maintained or improved compared to current LTM, since the WTRU benefits from being able to determine a best first cell, second cell, or third cell to perform cell switching to in advance of receiving a NW instruction to perform cell switching. This makes it faster for the WTRU to execute in all cases, whether failed ones or successful ones. This may be done even before the WTRU has access to measurements just before HO time.

Embodiments and examples herein include network capacity gains from reduced signaling for preparing candidates since a limited subset can be configured based on predictions. The NW can prepare a smaller subset of targets and hence the NW resource usage can be reduced, such as, for example, preparing resources on fewer potential target cells. Mechanisms proposed herein provide fallback options in case of failures and leverage on AI/ML for more robust decision making processes in LTM.

Especially in the case of failures, the proposed example solutions herein also provide latency benefits. Regardless of whether there is a legacy decision on the best target cell or a decision based on the mechanisms herein proposed, the WTRU may be configured with fallback options that can apply straightaway without the need to report to the NW, wait for NW commands, or performing additional steps for a decision.

Embodiments and examples herein include optimizing the set of candidate cells, which also benefits the WTRU from an energy consumption perspective and a data rate perspective, as measurement gap usage would be reduced and no exchanges of data are interrupted for certain WTRUs.

Embodiments and examples provided herein may rely on an initial configuration, typically received by the WTRU via RRC signaling, where the WTRU is configured with a set of candidate LTM cells. Linked with each cell, the WTRU may also get a configuration for the triggering of measurement predictions, that can later be used to determine the best decision possible on the best target cells.

In the examples provided herein, where the phrase current measurement is used, this phrase may refer to current actual measurements, for example, measurements which have been received at the radio receiver and evaluated by the WTRU. Additionally or alternatively, the phrase current measurement may refer to current predicted measurements, for example, measurements which have not been received at the radio receiver but rather have been determined based on a predictive model in the WTRU.

Embodiments and examples herein include successful LTM case enhancements, where upon reception of a cell switch command, the WTRU selects the best target cell based on current and predicted values. For example, a WTRU may receive a configuration with a set of one or more LTM candidate cells, for example, via RRC signaling, where the configuration may include an associated predictive measurement configuration per candidate cell, for example, one or more of the following: one or more measurement metrics; one or more L1 prediction triggers, for example, time or radio measurement values; a prediction time span; a procedure validity, for example, any one of or any combination of an inference periodicity, a moving window, or a one-time procedure; or one or more reporting criteria.

Further, the WTRU may predict, may infer, or both, one or more future L1 measurements for one or more cells in the configured LTM cell set, covering the prediction time span. For example, the WTRU may predict, may infer, or both, when triggered to predict, to infer, or both, one or more future L1 measurements by a configured L1 prediction trigger being satisfied. Also, the WTRU may transmit a measurement report to the network with the report containing current L1 measurements, predicted L1 measurements, or both, for at least one cell in the configured set of one or more LTM candidate cells.

In addition, the WTRU may receive an indication, for example, via a MAC CE, with one or more criteria, or an indication to one or more previously configured criteria, for best target cell selection amongst more than one cell, where the criteria include at least one of: a current L1 measurement value; at least one predicted L1 measurement value; or a time span for predictions, for confidence levels, or both. The WTRU may determine the best target cell based on the received criteria, the configured criteria, or both. Further, the WTRU may perform cell switching to the determined best target cell, based on the previous determination of both current L1 values and predicted L1 values. Accordingly, the WTRU may transmit a feedback indication containing at least one of the following: a measured radio metric value at the cell switch time, or a predicted radio metric value at the end of the prediction time span.

Examples provided herein include several L1 prediction triggers. For example, for each cell, the WTRU may be configured to trigger predictions based on current or predicted measurement thresholds. These can be L1 measurements, for example, channel state information (CSI)-RS, beam RSRP and the like. Additionally or alternatively, these can be RRM/L3 measurements, for example, cell RSRP measurements. Each cell may have their own measurement quantity or quantities associated, or a specific time for prediction triggering.

Examples of radio measurement related triggers include any one or any combination of the following: trigger predictions for cell A if current L1 RSRP falls below a threshold; trigger predictions for cell A if current L1 RSRP falls below a threshold for n consecutive time steps (sampling occurrences); trigger predictions for cell B if current L1 RSRP falls below a threshold and L3 signal-to-noise ratio (SNR) falls below a second threshold; trigger predictions for cell C if current L1 RSRP decreases at certain rate; trigger predictions for cell C if current L1 RSRP decreases at certain rate for n consecutive time steps (sampling occurrences); trigger predictions for cell D if a certain measurement event (for example, A2) is detected for cell D; or the like.

Examples of time related triggers include any one or any combination of the following: trigger predictions at a specific time stamp; trigger predictions when a timer t expires; or the like.

Examples of combined time and radio measurement triggers include trigger predictions for cell A after a specific time stamp and if a current L1 RSRP measurement falls below a threshold. Both time related examples and all measurement related examples can be combined with any one or more of each other.

Provided herein are prediction time span examples. In examples, prediction time span indicates to the WTRU until when the predictions should be inferred and may include a certain granularity that is different than the measurement sampling rate. For example, the WTRU may be configured with a sampling rate for L1 RSRP measurement of 20 ms but a prediction time span step may configure the WTRU to infer one measurement value every 100 ms.

Provided herein are procedure validity examples. In examples, the validity of the inference procedure is to account for cases where, for example, the predictions time span is not sufficient for the network to assess predicted measurements, or the time span is too long and there could be a higher estimated prediction error associated with some predicted values, and the like. The network could also require the WTRU to persistently predict radio measurements, in a predictive monitoring way. In some cases though, predicting radio measurements once may be sufficient.

For the cases when the WTRU is required to predict measurements multiple times, some example solutions are herein provided.

In one set of methods, the WTRU may trigger predictions one time only. On another set of methods, the WTRU may trigger predictions periodically. On a further set of methods, the WTRU may trigger the inference process in a moving window manner.

The WTRU may be configured with different options of the procedure re-use for different LTM candidate cells, according to NW requests or needs. The WTRU may be configured to: execute the procedure once for a particular cell; execute the procedure once for a set of cells; execute the procedure once all cells in the measurement configuration; execute the procedure once for all detectable cells; and the like.

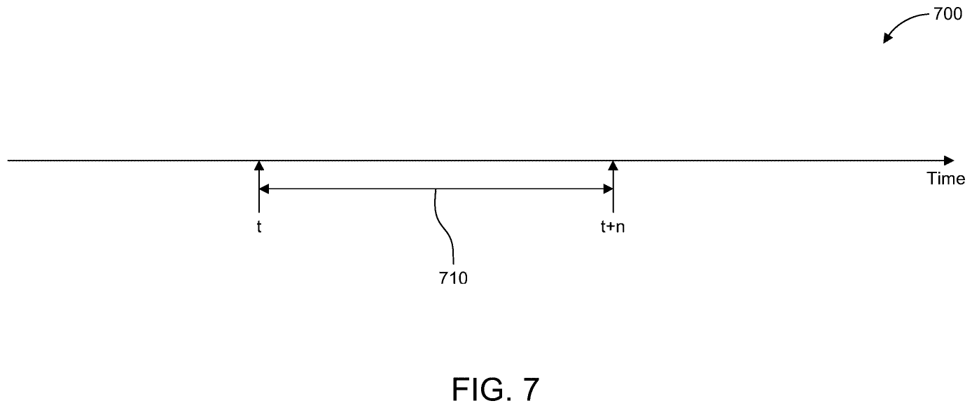

FIG. 7 is a timeline diagram illustrating an example of a one-time inference procedure window. In an example solution shown in timeline diagram 700, the WTRU will execute the inference procedure once only. The time span of the prediction 710 is straight forward. In an example shown in timeline diagram 700, an inference process window may be of size n. The time span of the prediction 710 starts at time t and ends at time t+n, as shown in an example in FIG. 7, when the WTRU executes the inference procedure just once. At time t, the WTRU may start the inference procedure, and a time t+n, the WTRU may make a prediction.

The same or similar applies for the recurrent inference procedure. The WTRU may be configured to execute the procedure recurrently for a particular cell. Also, the WTRU may be configured to execute the procedure recurrently for a set of cells. Further the WTRU may be configured to execute the procedure recurrently for all cells in the measurement configuration. Moreover, the WTRU may be configured to execute the procedure recurrently for all detectable cells; and the like.

This following example solution can be executed by the WTRU, based on NW configuration. Additionally or alternatively, the following example solution can be fixed in the standard in different forms, and be executed by the WTRU accordingly.

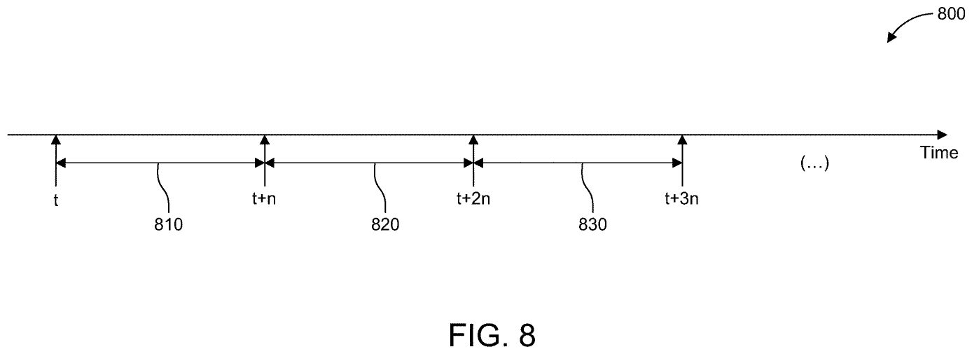

FIG. 8 is a timeline diagram illustrating an example of periodic WTRU predictions with window re-use. An example in timeline diagram 800 includes a simple form of periodic WTRU predictions, where for a particular cell, the WTRU may be configured with a value for n and periodically trigger predictions at multiples of n. Accordingly, one or more inference process windows of size n are shown in an example in FIG. 8.

For example, the time span of prediction 810 starts at time t and ends at time t+n, as shown in an example in FIG. 8, when the WTRU makes a periodic prediction. At time t, the WTRU may start an inference procedure. At time t+n, the WTRU may make a prediction, in an example. Further, after window re-use and a time span of prediction 820, the WTRU may make another prediction at time t+2n. Moreover, after a time span of prediction 830, the WTRU may make a further prediction at time t+3n. Timespans 810, 820, 830 may be of equal length, in an example shown in FIG. 8. Accordingly, the predictions of the WTRU are periodic.

The same or similar applies for the moving window procedure. The WTRU may be configured to: execute the moving window procedure for a particular cell; execute the moving window procedure for a set of cells; execute the moving window procedure for all cells in the measurement configuration; execute the moving window procedure for all detectable cells; and the like.

In the moving window example approach, the WTRU may perform inference in a moving window manner. This approach may be configured or fixed as the method in the standard. Two examples approaches may be envisioned. In one example solution, there is a fixed spacing configuration, y, after which the WTRU (starting from time t) would re-run the inference process, as explained in more detail below.

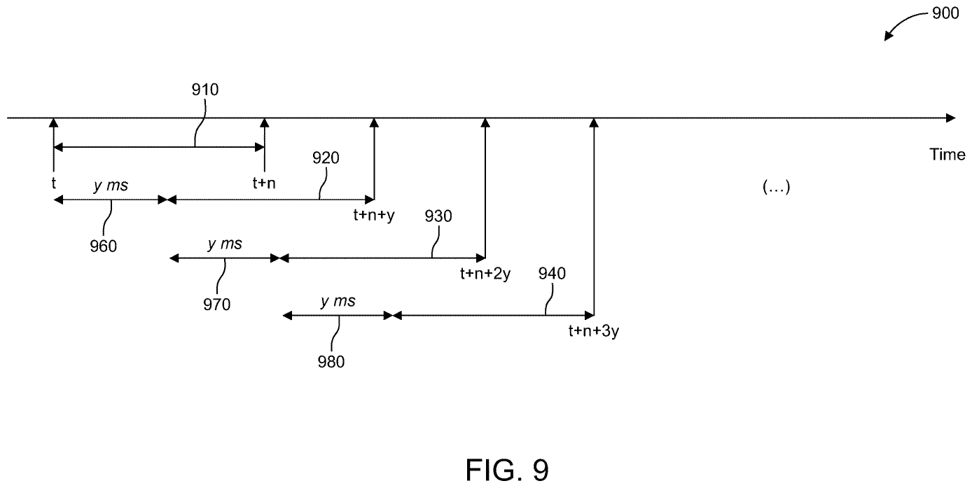

FIG. 9 is a timeline diagram illustrating an example of a WTRU moving window inference procedure with spacing and window re-use. In an example shown in timeline diagram 900, the inference process window would be of fixed size n.

For example, the WTRU may start an inference procedure at time t. After a time span of prediction 910, which starts at time t and ends at time t+n, the WTRU makes a prediction. Further, after a fixed spacing 960 of y ms, the WTRU may then start another inference procedure with a time span of prediction 920, ending at time t+n+y, when the WTRU makes a prediction. Also, after a fixed spacing 970 of y ms, the WTRU may then start a further inference procedure with a time span of prediction 930, ending at time t+n+2y. The WTRU makes a prediction at time t+n+2y. Moreover, after a fixed spacing 980 of y ms, the WTRU may then start yet another inference procedure with a time span of prediction 940, ending at time t+n+3y. The WTRU makes a prediction at time t+n+3y. In this way, the WTRU may engage in a moving window inference procedure with spacing and window re-use with a fixed spacing configuration.

In a second approach of a moving window inference procedure with spacing and window re-use, the WTRU may be configured with one or more back-off timers. These back-off timers would make the WTRU refrain from performing inference for a certain amount of time. This could be useful because the NW may have an estimation of when WTRU prediction support would be required and could in this way limit the WTRU's battery and computational resources usage.

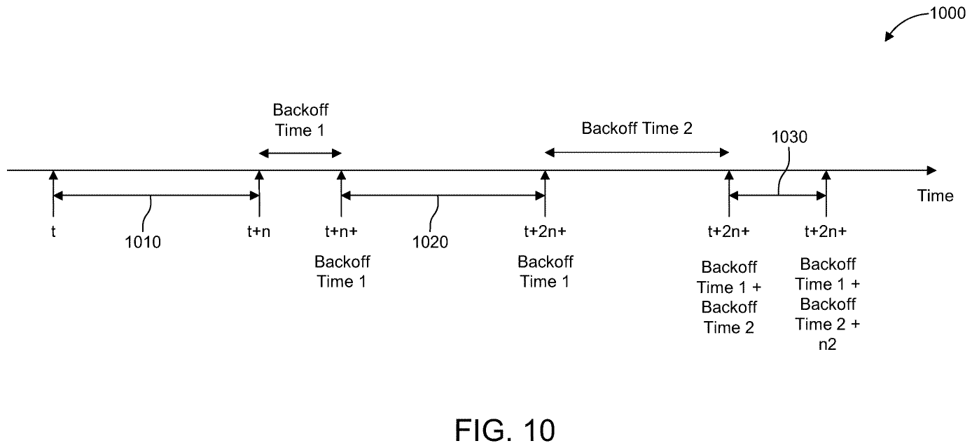

FIG. 10 is a timeline diagram illustrating an example of periodic WTRU predictions with configured window settings. Different back-off timers could be set before the WTRU performs inference and every time this happens, the WTRU could be configured with windows of different sizes (n, n2, etc.), as depicted in an example shown in timeline diagram 1000.

For example, the WTRU may start an inference procedure at time t. The inference procedure may have a time window size of n. Accordingly, after a time span of prediction 1010, which starts at time t and ends at time t+n, the WTRU makes a prediction. Then, after a back-off time 1, another inference procedure may begin. Accordingly, at time t+n+back-off time 1, the WTRU may start another inference procedure. The inference procedure may also have a time window size of n. As a result, after a time span of prediction 1020, which starts at time t+n+back-off time 1 and ends at time t+2n+back-off time 1, the WTRU makes another prediction. Further, after a back-off time 2, another inference procedure may begin. The inference procedure may have a time window size of 2n, which may be a different size than the time window size of n. For example, the time window size of 2n may be smaller than the time window size of n. Accordingly, at time t+2n+back-of time 1+back-off time 2, the WTRU may start another inference procedure. As a result, after a time span of prediction 1030, which starts at time t+2n+back-off time 1+back-off time 2 and ends at time t 2n+back-off time 1+back-off time 2+n2, the WTRU makes another prediction.

In an example, the back-off times, for example back-off time 1, back-off time 2, or both may be governed by back-off timers. For example, a counter may be used by the WTRU to determine the end of a back-off time. The WTRU may determine that a certain amount of time has elapsed at the end of a back-off time through the use of a back-off timer, in an example.

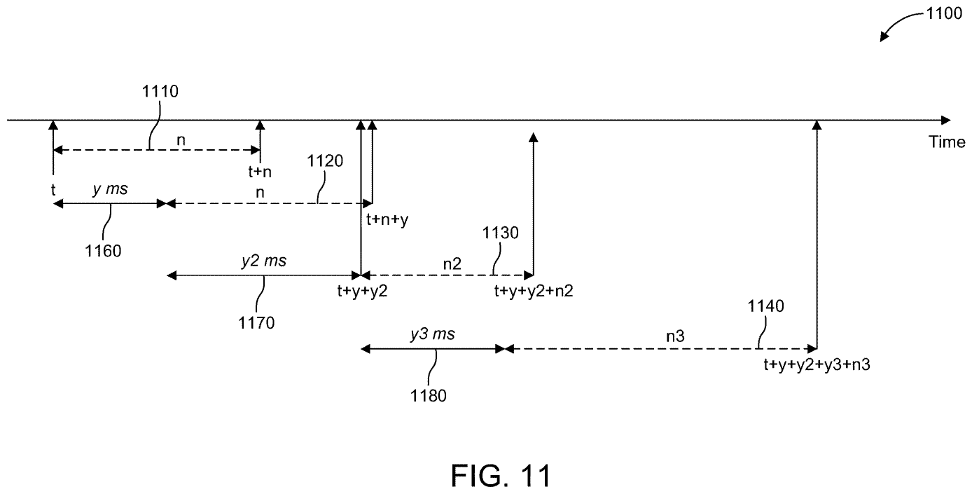

FIG. 11 is a timeline diagram illustrating an example of a WTRU moving window inference procedure with configurable spacing and window. In another example solution, both the spacing, y, and the time span of the predictions, n, can be configured for different values. This is shown in an example in timeline diagram 1100.

A WTRU moving window inference procedure with configurable spacing and window would be useful again in cases where the NW takes into account internal predictions and estimates, for example that an event might occur around time n. The WTRU then executes inference until t+n. If no event is predicted, it makes sense that the WTRU re-runs inference at time t+y. If an event is predicted, it makes sense as well to re-run inference at time t+y so that the newer predictions have lower associated error.

The NW may have as well prediction results that conclude no events will happen around time t+n+y. For this reason, it would be beneficial to spare the WTRU from extra computations and introduce y2, with a high confidence that the likelihood of an event is very low.

Similarly, it makes sense that the solution allows for the possibility to adjust the inference window, by tuning n. For example, the WTRU may use n, n2, n3, and the like. The longer the window is, the higher the errors associated with predictions will be. The likelihood of the WTRU experiencing a configured measurement event can therefore be used to tune the value of n for different occasions, where likely the window will be longer if the NW is confident there will be no event detected or predicted, and the window will be shorter otherwise.

For example, the WTRU may start an inference procedure at time t. After a time span of prediction 1110 of size n, which starts at time t and ends at time t+n, the WTRU makes a prediction. Further, after a spacing 1160 of y ms, the WTRU may then start another inference procedure with a time span of prediction 1120 of size n, ending at time t+n+y, when the WTRU makes a prediction.

Also, after another spacing 1170 of y2 ms, the WTRU may then start a further inference procedure at time t+y+y2, with a time span of prediction 1130 of size n2, ending at time t+n+2y+n2, when the WTRU makes a prediction. Moreover, after a spacing 1180 of y3 ms, the WTRU may then start yet another inference procedure with a time span of prediction 1140 of size n3, ending at time t+y+y2+y3+n3. The WTRU may make a prediction at time t+y+y2+y3+n3. In this way, the WTRU may engage in a moving window inference procedure with configurable spacing and a configurable window.

The choice of triggers for measurement predictions presented here should also be considered dynamic. In certain cases, the WTRU may be required to always infer recurrently. In some others, the refreshing rate, how often the WTRU triggers predictions, may be dependent upon current or predicted measurement values. For example, the WTRU may predict measurements once, and with those predictions determine that a particular cell's measurement values will not reach a certain threshold. In that case, certain conditional triggering criteria may apply, where n and y are dependent upon certain predicted values.

In one example set of solutions, the WTRU is configured with more than one option for n, y and back-off timer. Examples include cases where there can be more than one n, y and back-off timer, such as the following example cases. In an example, if the predictions for a time span do not reach one or more certain thresholds, the WTRU may use a second back-off timer.

In another example, if one or more predictions for a time span reach one or more certain thresholds, but the accuracy/confidence level does not reach another threshold, the WTRU may use any one or any combination of a second back-off timer, a second value for n, or a second value for y. If one or more predictions for a time span do not reach one or more certain thresholds for a certain number of triggering occasions, regardless or not of the accuracy/confidence level of those predictions, then the WTRU may use any one of or any combination of a second n, a third n, a second y, a third y, a second back-off timer, or a third back-off timer, in an addition example.

In a further example, if one or more predictions for a time span reach one or more certain thresholds for one or more number of triggering occasions, the WTRU may switch to recurring predictions triggering. If one or more predictions for a time span are within certain intervals, the WTRU may override any one or any combination of a previous back-off timer, n, or y, and the WTRU may not trigger prediction again. Similar example cases may also be used.

The updating or refreshing rate for the WTRU predictions can also be used to configure the WTRU to log predicted values. The WTRU may be configured to store any one of or any combination of the following: a previous n number of predictions from each triggering occasion; all the predictions for all triggering occasions; or a subset of the predictions for all triggering occasions where the predictions are higher than a threshold or lower than a threshold, further filtered by having an estimated error/confidence value higher than another threshold or lower than another threshold.

These can be part of a different configuration for each cell individually, further filtered by storing only if any one or any combination of a current n, y or back-off timer being used is higher than a threshold or lower than a threshold, in an example.

In examples provided herein, a reporting criteria may be included for each cell. The intention of this configuration is to later have the WTRU transmitting predictions over to the NW and hence, this is a necessary step. The criteria may be associated with other examples provided elsewhere herein, such as those related to measurement thresholds, where the WTRU is configured to report measurements with a certain granularity. The longer the future time span of the predictions, the higher the probability of lower accuracy of the predictions. Hence, the NW may configure the WTRU with a different time span for reporting than for inferring. The criteria may also be used to filter measurements. The WTRU may be configured, for example, to report only: predicted values above a threshold or below a threshold; average predicted values for the prediction time span; moving average values for the prediction time span with an associated value for the moving window; only predicted values with an estimate error lower than a threshold; and the like.

Examples of predicting/inferring one or more future L1 or RRM/L3 measurements may include the same or similar examples as for L1 or RRM/L3 prediction triggers. In an example at least one of the criteria listed for L1 prediction triggers or RRM/L3 prediction triggers has been met for at least one cell and the WTRU predicts the target one or more radio metrics.

In an example, the WTRU may transmit a measurement report including the predicted values in accordance to the configuration received by the WTRU.

Examples are provided herein of the WTRU receiving one or more criteria for the best target cell selection amongst more than one cell, where the criteria include at least one predicted L1 measurement value. In an example, for each LTM candidate cell, the WTRU may receive associated predicted future values by the NW, so it can make a decision on the best target cell based on the current measurement value and predicted values. Associated with the one or more values, there could be a time indication. In case the WTRU is to use its own predictions, the NW may send for example more than one time indication but only one predicted value. The WTRU implicitly then know it should use its own predictions. For example, the NW may indicate one predicted value and indicate at the same time three (3) time steps to consider. The WTRU would then use its own predicted values for the remaining two (2).

Examples are provided herein of the WTRU receiving one or more criteria for the best target cell selection amongst more than one cell, where the criteria include a time span for predictions, confidence levels or both. In an example, the network may decide the decision is completely up to the WTRU. In this example case, a time span and confidence values are the only requirement.

Examples of criteria for WTRU decision making for choosing the best target cell by the WTRU include any one or any combination of the following. The WTRU may choose cell A if a current measurement is above a threshold or under a threshold, and a predicted value with time span x is above a second threshold or under a second threshold, in an example. In another example, the WTRU may choose cell B if a current measurement is above a threshold or under a threshold and all predicted values with time span x are above a second threshold or under a second threshold.

In a further example, the WTRU may choose cell C if a current measurement is above a threshold or under a threshold, and a subset of at least n of all the predicted values with time span x are above a second threshold or under a second threshold. In an additional example, the WTRU may choose cell A if current measurement is above a threshold or under a threshold, and a predicted value with time span x is above a confidence level threshold. Moreover, the WTRU may choose cell B if a current measurement is above a threshold or under a threshold, and all predicted values with time span x are above a confidence level threshold, in an example. Also, the WTRU may, for example, choose cell C if a current measurement is above a threshold or under a threshold, and a subset of at least n of all the predicted values with time span x are above a confidence level threshold. Further, the WTRU may choose the target cell with the highest radio signal quality out of the indicated candidate cells. In an example, the highest radio signal quality may be the highest actual RSRP. In another example, the highest radio signal quality may be the highest predicted RSRP.

Based on the above, the WTRU may determine the best candidate cell and perform cell switch towards the best candidate cell. Examples are provided herein of the WTRU determining the best target cell and performing cell switching.

Examples are provided herein of the WTRU transmitting a feedback indication containing a measured radio metric value at the cell switching time. In an example, current radio measurement may be included for any candidate LTM cell. It may be relevant for the NW to receive just an immediate value at the time of cell switch, or a set of values before the cell switch was executed. This can be useful for improving its decision making process.

In one example solution, the WTRU transmits just one measurement value at the time of cell switch for one, more than one, or all cells in the configured set. In one example solution, the WTRU transmits all measurement values a certain past time x before the cell switch for one, more than one, or all cells in the configured set. In one example solution, the WTRU transmits only measurement values that were higher than or above a threshold for a certain past time window x before the cell switch for one, more than one, or all cells in the configured set. In one example solution, the WTRU transmits only measurement values that were higher than or above a threshold for a certain time window x before the cell switch for one, more than one, or all cells in the configured set.

Examples are provided herein of the WTRU transmitting a feedback indication containing a predicted radio metric value at the end of the prediction time span. In an example, all predicted radio measurements or any considered filtering described may be applied here for each of the cells. WTRU generated predictions can be included considering any one of or any combination of confidence intervals, error of the predictions, accuracy of the predictions, or relative offset thresholds between the previously generated predictions and the past measured values. Further, WTRU generated predictions may include a certain past time window or not, just like for feedback containing a measured radio metric value. Examples include the following. In one example solution, the WTRU transmits just one predicted value at the time of cell switch for one, more than one, or all cells in the configured set. In one example solution, the WTRU transmits all predicted measurement values within a certain past time window x, or a certain confidence interval from the initial prediction trigger (a confidence interval defines a time span), before the cell switch for one, more than one, or all cells in the configured set. In one example solution, the WTRU transmits only predicted measurement values that were higher than a threshold or above a threshold for a certain time window x, or lower than or higher than a certain offset threshold from the current measurement at that time, before the cell switch for one, more than one, or all cells in the configured set.

The transmission of the listed predictions can be further filtered or not based on one or more of: error of the prediction or accuracy of the prediction that was higher than x or lower than x; or the relative offset threshold between the predicted value and the prediction at a past time being higher than y or lower than y.

Embodiments and examples herein include a failure case for LTM, where, upon failure, the WTRU performs cell switching to a fallback cell, a second cell, or a cell considered to be both, based on predicted radio measurements for the fallback targets, the second targets, or both. For example, a WTRU may receive, for example, via RRC signaling, a configuration with a first cell and one or more dependent second cells, where the configuration includes at least one of the following per configured cell: one or more radio measurement thresholds, such as, for example, an L1 RSRP; or L1 prediction triggers, such as, for example, time values or measurement values.

Further, the WTRU may receive an indication, for example, via a MAC CE, of a target cell to be designated as a first cell and one or more target cells to be designated as the one or more dependent second cells, where for each of the one or more dependent second cells, at least one of the following is included: one or more radio measurement thresholds; one or more network-predicted L1 measurement values; a time span for the WTRU-predicted values; or one or more criteria, or indications for a previously configured one or more criteria, for a network L1 measurement prediction assessment, where the one or more criteria includes at least one of: a threshold used for WTRU-predicted measurement values and network-predicted measurement values, or a threshold used for WTRU-measured measurement values and network-predicted measurement values. Additionally, the WTRU may attempt cell switching toward the first target cell. Also, the WTRU may determine a failure on the cell switch to a first target cell based on, for example, RACH failure, loss of synchronization, security establishment failure, and the like.

Moreover, the WTRU may determine a second best target dependent cell from the one or more target cells designated as one or more second cells, based on at least one of network-predicted measurement values, WTRU-measured measurement values, and one or more indicated criteria. In addition, the WTRU may perform cell switching towards the determined second best target cell. Further, the WTRU may transmit a feedback indication containing at least one of the following: a measured radio metric value for the determined second best target cell; or a predicted radio metric value for the determined second best target cell.

In examples of the WTRU receiving a configuration, the WTRU may receive a configuration for a first cell (or more than one), where for each of the cells there can be one or more dependent cells that are always associated with the first cell. Also, the second cells may be associated with some included prediction triggers. In examples, the prediction triggers may be the same as or similar to those as in examples provided herein for the L1 prediction triggers under the successful LTM case, or the RRM/L3 prediction triggers.

In examples of the WTRU receiving an indication, the WTRU may receive an indication of a first target cell and one or more second targets cells. In an example, the one or more second target cells may be in a set of second target cells. This indication may be different than the previous configuration as the set of second targets cells may be a subset of the initially configured target second cells.

In examples, the indication may include one or more network-predicted L1 measurement values. Specifically, for each second cell associated with a first target cell, the WTRU may receive network generated predictions. The network may include a set of values, one value and a time span, a time span and a set of values, and the like.

In examples, the indication may include a time span for WTRU-predicted values. Specifically, the WTRU may receive a time span for the predictions which may have a format of a time, an accuracy value, a confidence interval, and the like. The WTRU may use this time span to filter which predicted values to use based on previously triggered predictions. The triggered predicted may be as indicated by the network in the L1 prediction triggers included in the configuration received by the WTRU. The WTRU may also receive triggering criteria for inferring predicted measurement, in case they need to be inferred for the decision making process upon reception of the MAC CE, where the criteria may include any of the options listed in the procedure validity example of the configuration received by the WTRU, as in the successful LTM case.

In examples, the indication may include one or more criteria for network L1 measurement prediction assessment. Specifically, depending on the solution, the NW may require the WTRU to use its own predictions, current measurement values, or network predictions. The thresholds indicated can be used in several forms.

In different example solutions, the WTRU uses the NW predictions to compare with current measurement values. Every time slot, the WTRU compares the NW predicted value with the current measurement value. The WTRU may select a second cell from the available set based on absolute thresholds, which may be as in the following examples. For example, the WTRU may select a second cell if the difference between NW predicted values and current measurement values is under a threshold every time slot over the prediction span. In another example, the WTRU may select a second cell if the difference between NW predicted values and current measurement values is under a threshold in at least n time slots over the prediction span. In a further example, the WTRU may select a second cell if the difference between NW predicted values and current measurement values is under a threshold for the first y time slots over the prediction span.

In another set of example solutions, the WTRU may select a second cell from the available set based on relative thresholds, which may be as in the following examples. For example, the WTRU may select a second cell if the difference between NW predicted values and current measurement values is under an offset threshold every time slot over the prediction span, and the current measurement values are higher/lower than x. In a further example, the WTRU may select a second cell if the difference between NW predicted values and current measurement values is under an offset threshold in at least n time slots over the prediction span, and the current measurement values are higher than x or lower than x. In another example, the WTRU may select a second cell if the difference between NW predicted values and current measurement values is under an offset threshold for the first y time slots over the prediction span, and the current measurement values are higher than x or lower than x.

In a different set of example solutions, the WTRU uses the NW predictions to compare with its own predicted measurement values. Every time slot, the WTRU compares the NW predicted value with the predicted measurement value. The WTRU may select, similarly to the above, a second cell from the available set based on one or more of the following examples. The difference between NW predicted values and WTRU predicted measurement values is under a threshold every time slot over the prediction span. The difference between NW predicted values and WTRU predicted measurement values is under a threshold in at least n time slots over the prediction span. The difference between NW predicted values and WTRU predicted measurement values is under a threshold for the first y time slots over the prediction span. All of the above given that the accuracy of the WTRU prediction is higher than a threshold for all or a subset of the compared predictions. Similar examples may also be used.

In a different set of example solutions, the WTRU uses its own predictions to select a second cell. In this case, the time span of the indication received by the WTRU may apply.

Examples include a WTRU attempting cell switching and determining a failure. Specifically, the WTRU may attempt a cell switch to a first target cell but a failure occurs. Failure here refers to, for example, the predicted values received from the NW and the current measurements not being a match, or at least being different by a certain minimum amount. This may be valid for the first target cell or for any second target cell. Further modifications of aspects of this example approach may be added to those here in further updates. Other types of failure include any conditions that can lead to the WTRU not being able to transmit on any resources to the target cell. This can include RACH failure, loss of synchronization, security establishment failure or any other type of failure that may or may not lead to the WTRU declaring RLF, performing cell searching procedure, or performing cell re-establishment procedure.

In an example of the WTRU determining a second best target cell, the determination may be based on the received indication. In an example of the WTRU performing a cell switch, the WTRU may perform a cell switch towards the determined second best target cell as a fallback.

In an example of the WTRU transmitting feedback, the current/measured radio measurement may be included for second cell dependent on the first cell. In another example of the WTRU transmitting feedback, all predicted radio measurements or any considered filtering described may be applied here for each of the second cells.

Transmitting feedback may be an important step because it may ensure the WTRU supports the NW refining the initial set of candidate cells. After this feedback step, the NW should be able to optimize the procedure when it next starts with transmitting a configuration to a WTRU.

Embodiments and examples herein include multi-cell monitoring management, where upon being configured with one or more LTM candidate cell sets, the WTRU assists the network in reducing the size of the set to monitor, based on predicted radio measurements. For example, a WTRU may receive a configuration for an LTM candidate cell group, including at least one of: one or more candidate cells; one or more measurement metrics; a validity time; one or more thresholds for triggering predictions, such as time values or measurement values, for one or more cells of the configured LTM candidate cell group; or one or more criteria to determine the one or more cells for which the WTRU is to continue monitoring. For example, the WTRU may continue monitoring a cell if a predicted measurement value is above a threshold.

Further, the WTRU may predict, infer, or both, one or more future L1 measurement values for one or more candidate cells in the configured LTM cell group. Also, the WTRU may determine a selected subset of one or more candidate cells to continue monitoring from the received configuration, based on at least a predicted L1 measurement values or a configured criterion. Additionally, the WTRU may transmit an indication, for example, via a MAC CE, to the network of the selected subset of one or more candidate cells, where the indication includes at least one of: one or more predicted L1 measurement values of the one or more cells of the selected subset; one or more timings associated with predicted L1 measurement values; one or more measured radio metric values for one or more cells of the first LTM candidate cell group not included in the selected subset of one or more candidate cells; or one or more predicted radio metric values for one or more cells of the first LTM candidate cell group not included in the selected subset of one or more candidate cells.

Moreover, the WTRU may receive an indication, for example, via a MAC CE, configuring a second LTM candidate cell group, including one or more criteria, or an indication of a previously configured one or more criteria, associated with each candidate cell in the second LTM candidate cell group. Also, the WTRU may determine a candidate cell of the second LTM candidate cell group for which a cell switch criteria has been met and performing cell switch to the determined candidate cell. In addition, the WTRU may transmit on resources associated with the determined candidate cell.

Specifically, in an example, a WTRU may receive a configuration with a set of candidate cells for LTM. Further, for each cell, the WTRU may receive a validity time included in the configuration.

In examples, the configuration may include thresholds for triggering one or more predictions. For example, associated with each of the cells there may also be some prediction triggers included, which are the same or similar as those listed in the L1 prediction triggers in the configuration received in the successful LTE case. However, a few more additional criteria may be included, due to the validity time aspect. Hence, in addition to what is listed in the L1 prediction triggers in the configuration received in the successful LTE case, other radio measurement related triggers include all of those listed herein, if the condition holds during validity time.

In examples regarding the received configuration, the WTRU may be configured with a criteria for monitoring and filtering of cells to continue to monitor. The criteria may include current measurements, predicted measurements over a time span and may include validity time. Examples of criteria are for the WTRU to keep monitoring a cell if any one or any combination of the following examples apply.

For example, the WTRU may continue monitoring a call if current one or more measurements are above a threshold or under a threshold during the validity time. Further, the WTRU may continue monitoring a call if current one or more measurements and predicted measurements over a time span are above a threshold or under a threshold during the validity time, where the time span is longer than the validity time, in an example. In another example, the WTRU may continue monitoring a call if predicted measurements over a time span are above a threshold or under a threshold during the validity time, where the time span may or may not be longer than the validity time. Moreover, the WTRU may continue monitoring a call if at least n predicted measurements over a time span are above a threshold or under a threshold during the validity time, where the time span may or may not be longer than the validity time.

In a further example, the WTRU may continue monitoring a call if at least n predicted measurements over a time span are above a threshold or under a threshold during the validity time, and the predictions have an estimated confidence/error value below a threshold, where the time span may or may not be longer than the validity time. In yet a further example, the WTRU may continue monitoring a call if predicted measurements for a cell over a time span are above an offset threshold or under an offset threshold when compared to another cell. Further, the WTRU may keep monitoring if the total number of cells that meet the keep monitoring criteria is below a threshold. Moreover, the WTRU may keep monitoring if a particular cell in the set is flagged as to keep monitoring. Similar examples may also apply.

In examples, the WTRU may infer and determine the set of cells to continue monitoring. In further examples, the WTRU may transmit an indication to indicate to the NW which is the determined cell set to continue monitoring. Along with the indication, the WTRU may include any one of or any combination of the following examples.

Specifically, in examples, the WTRU may transmit an indication including predicted L1 measurement values with all of the predicted values or a filtered subset of them. Different filtering example solutions include transmitting only: predicted values above a threshold or below a threshold; average predicted values for the prediction time span; moving average values for the prediction time span with an associated value for the moving window; only predicted values with an estimate error lower than a threshold; and the like.

Further, in examples, the WTRU may transmit an indication including timings associated with predicted L1 measurement values. In examples, timings may be indicated by timestamps. However, because likely a MAC CE will be used and the amount of information that can be contained in it is reduced, other options can include: a timestamp (when the predictions started, when the predictions ended, when the predictions hit a certain accuracy threshold or confidence threshold, when the predictions hit a certain error threshold or estimated error threshold); a number of predictions; estimated error of one or more predictions; accuracy, confidence., or both of one or more predictions; a time step granularity (delta between time steps); an index to a lookup table containing at least granularity of time steps, number of predicted steps, estimated error values or intervals, confidence values or intervals, and the like; and the like.

Moreover, in examples, the WTRU may transmit an indication including one or more measured radio quantities for any cell not part of the determined excluded cell group. Further, the indication may include one or more predicted measured radio quantities for any cell not part of the determined excluded cell group.

In examples, the WTRU may receive a second configuration with a second LTM candidate cell group that may include either a new criteria for any cell in the cell group determined to keep monitoring, or an indication of a previously configured criteria from the first LTM candidate cell group, that is now associated with a cell in the second LTM group.

The WTRU may now determine the new criteria, or the indicated previously configured criteria for a first LTM candidate cell group, has been met for a cell in the second LTM cell group. The WTRU may then perform cell switch.

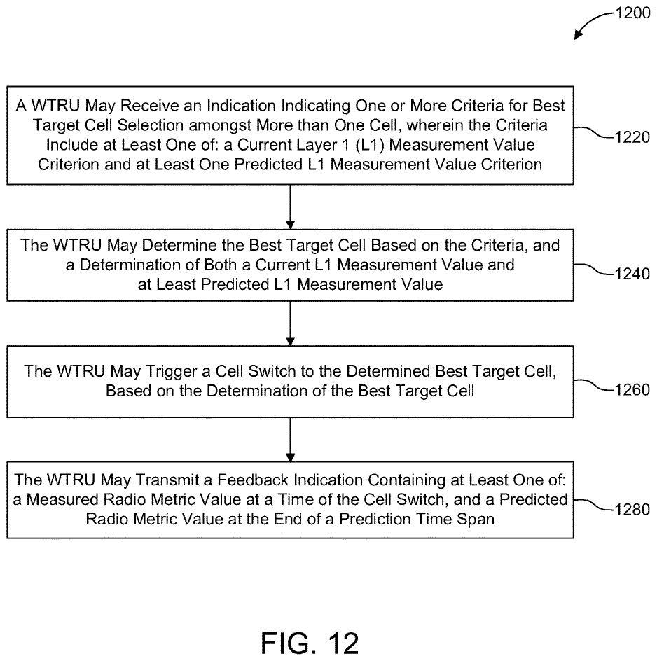

FIG. 12 is a flow chart diagram illustrating an example of a WTRU selecting the best target cell based on current and predicted values. In an example shown in flow chart diagram 1200, a WTRU may receive an indication indicating one or more criteria for best target cell selection amongst more than one cell, where the criteria include at least one of: a current L1 measurement value criterion and at least one predicted L1 measurement value criterion 1220. Then, the WTRU may determine a best target cell based on the criteria, and a determination of both a current L1 measurement value and at least one predicted L1 measurement value 1240. Further, the WTRU may trigger a cell switch to the determined best target cell, based on the determination of the best target cell 1260. Moreover, the WTRU may transmit a feedback indication containing at least one of: a measured radio metric value at a time of the cell switch, and a predicted radio metric value at the end of a prediction time span 1280.

In a further example, the criteria may further include at least one of the prediction time span and a confidence level. In another example, the criteria may further include one or more previously configured criteria. In an additional example, the received indication may be received via a MAC control element CE.

Also, the WTRU may receive a configuration with a set of one or more LTM candidate cells. In an example, the configuration may include an associated predictive measurement configuration per candidate cell for one or more: one or more measurement metrics, one or more L1 prediction triggers, the prediction time span, procedure validity, or a reporting criterion. The configuration may be received via RRC signaling, in an example. In another example, the one or more L1 prediction triggers may include one or more of time measurement value or radio measurement values. In a further example, the procedure validity may include one or more of an inference periodicity, a moving window, or a one-time procedure.

Additionally, triggering the cell switch may include one or more of an early UL synchronization, an early DL synchronization, or triggering CSI measurement and reporting, in an example. In a further example, the WTRU may predict one or more future L1 measurements for one or more cells in set of one or more LTM candidate cells, covering the prediction time span. Moreover, the WTRU may transmit a measurement report to a base station, wherein the report includes current L1 measurements and predicted L1 measurements for at least one cell in the set of one or more LTM candidate cells.

In another example the WTRU may receive a configuration with a set of one or more LTM candidate cells, for example, via RRC signaling, where the configuration may include an associated predictive measurement configuration per candidate cell, for example, one or more of the following: one or more measurement metrics; L1 prediction triggers, for example, time or radio measurement values; prediction time span; procedure validity, for example, inference periodicity, moving window, and/or one-time procedure; or a reporting criterion.

Further, the WTRU may predict, may infer, or both, one or more future L1 measurements for one or more cells in the configured LTM cell set, covering the prediction time span. For example, the WTRU may predict, may infer, or both, when triggered to predict, triggered to infer, or both, one or more future L1 measurements by a configured L1 prediction trigger being satisfied. Also, the WTRU may transmit a measurement report to the network with the report containing current L1 measurements, predicted L1 measurements, or both for at least one cell in the configured set of LTM candidate cells.

In addition, the WTRU may receive an indication, for example, via a MAC CE, with one or more criteria, or an indication to one or more previously configured criteria, for best target cell selection amongst more than one cell, where the criteria include at least one of: a current L1 measurement value; at least one predicted L1 measurement value; or a time span for predictions and/or confidence levels. The WTRU may determine the best target cell based on the received criteria, the configured criteria, or both. Further, the WTRU may perform cell switching to the determined best target cell, based on the previous determination of both current and predicted L1 values. Accordingly, the WTRU may transmit a feedback indication containing at least one of the following: a measured radio metric value at the cell switch time, or a predicted radio metric value at the end of the prediction time span.

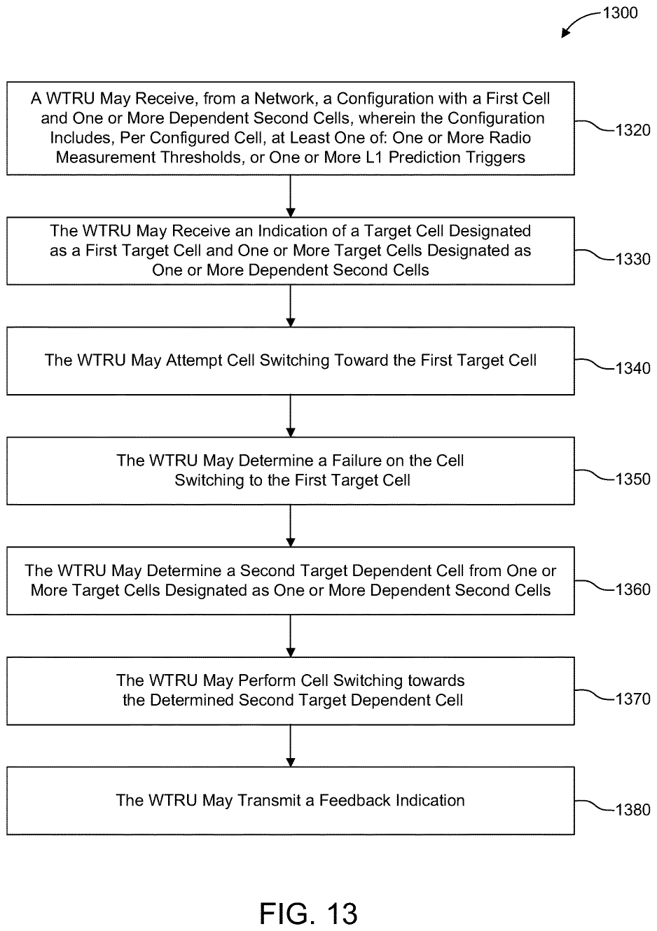

FIG. 13 is a flow chart diagram illustrating an example of a WTRU switching cells to a fallback cell based on predicted radio measurements. In an example shown in flow chart diagram 1300, a WTRU may receive a configuration with a first cell and one or more dependent second cells 1320. In an example, the configuration may include at least one of the following per configured cell: one or more radio measurement thresholds, or one or more L1 prediction triggers 1320, such as, for example, time or measurement values. The WTRU may also receive an indication of a target cell designated as the first target cell and one or more target cells designated as the one or more dependent second cells 1330. The received indication may include one or more of network-predicted L1 measurement values; a time span for the WTRU-predicted measurement values; or criteria, or indications for a previously configured one or more criteria, for a network L1 measurement prediction assessment. Additionally, the WTRU may attempt cell switching towards the first target cell 1340. Also, the WTRU may determine a failure on the cell switching to the first target cell 1350.

Further, the WTRU may determine a second target dependent cell from the one or more target cells designated as one or more dependent second cells 1360. In an example, the determination of the second target dependent cell may be based on one or more network-predicted L1 measurement values. Additionally or alternatively, the determination of the second target dependent cell may be based on one or more WTRU-measured measurement values. Additionally or alternatively, the determination of the second target dependent cell may be based on the received indication. Additionally or alternatively, the determination of the second target dependent cell may be based on one or more indicated criteria.

In addition, the WTRU may perform cell switching towards the determined second target cell 1370. Further, the WTRU may transmit a feedback indication 1380. In an example, the feedback indication may contain at least one of the following: a measured radio metric value at a cell switching time; or a predicted radio metric value at the end of a prediction time span. In an example, the second target dependent cell may be a second best target dependent cell. In a further example, the configuration may be received from a base station. The base station may be a gNB, in an example.

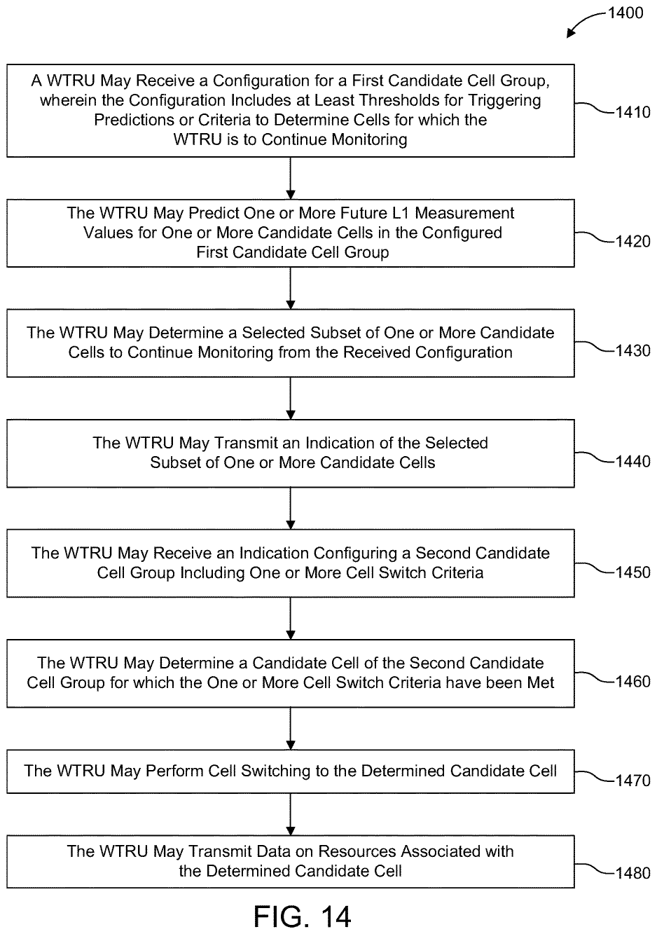

FIG. 14 is a flow chart diagram illustrating an example of a WTRU reducing the size of a candidate cell set to monitor. As shown in flow chart diagram 1400, a WTRU may receive, from a network or a base station, a configuration for a first candidate cell group 1410. In an example, the first candidate cell group may be a first layer 1 (L1)/layer 2 (L2) triggered mobility (LTM) candidate cell group. Further, the configuration may include at least one of: one or more candidate cells; one or more measurement metrics; a validity time; one or more thresholds for triggering predictions, such as time or measurement values, for one or more cells of the configured first candidate cell group; or one or more criteria to determine the cells for which the WTRU is to continue monitoring 1410. For example, the WTRU may continue monitoring a cell if a predicted measurement value is above a threshold. In addition, the WTRU may predict, may infer, or both, one or more future L1 measurement values for one or more candidate cells in the configured first candidate cell group 1420. Also, the WTRU may determine a selected subset of one or more candidate cells to continue monitoring from the received configuration 1430. In an example, the determination may be based on at least a predicted L1 measurement values or a configured criterion.

Further, the WTRU may transmit an indication, to the network or the base station, of the selected subset of one or more candidate cells 1440. In an example, the indication may be transmitted via a MAC CE. In a further example, the indication may include at least one of: a predicted L1 measurement values of a candidate cell of the selected subset of one or more candidate cells; the one or more cells of the selected subset; timings associated with predicted L1 measurement values; measured radio metric value for one or more cells of the first LTM candidate cell group not included in the selected subset of one or more candidate cells; or predicted radio metric values for one or more cells of the first LTM candidate cell group not included in the selected subset of one or more candidate cells. Further, the WTRU may receive an indication configuring a second candidate cell group including one or more cell switch criteria 1450. In an example, the indication may be received via a MAC CE. In an example, the transmitted indication may include previously configured one or more cell switch criteria associated with each candidate cell in the second candidate cell group. In another example, the transmitted indication may include one or more cell switch criteria associated with each candidate cell in the second candidate cell group. In a further example, the received indication may be received from the base station responsive to the transmitted indication.

In an example, the second candidate cell group may be a second LTM candidate cell group. Also, the WTRU may determine a candidate cell of the second LTM candidate cell group for which one or more cell switch criteria have been met 1460. Further, the WTRU may perform cell switching to the determined candidate cell 1470. In addition, the WTRU may transmit data on one or more resources associated with the determined candidate cell 1480.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving an indication indicating criteria for best target cell selection amongst more than one cell, wherein the criteria include: a current layer 1 (L1) measurement value criterion, at least one predicted L1 measurement value criterion, a prediction time span and a confidence level;
determining a best target cell based on the criteria, and a determination of both a current L1 measurement value and at least one predicted L1 measurement value;
triggering a cell switch to the determined best target cell, based on the determination of the best target cell; and
transmitting a feedback indication containing at least one of: a measured radio metric value at a time of the cell switch, and a predicted radio metric value at the end of the prediction time span.

2. (canceled)

3. The method of claim 1, wherein the criteria further include one or more previously configured criteria.

4. The method of claim 1, wherein the received indication is received via a medium access control (MAC) control element (CE).

5. The method of claim 1, further comprising:
receiving a configuration with a set of one or more L1/layer 2 (L2) triggered mobility (LTM) candidate cells, wherein the configuration includes an associated predictive measurement configuration per candidate cell for one or more:
one or more measurement metrics, one or more L1 prediction triggers, the prediction time span, procedure validity, or a reporting criterion.

6. The method of claim 5, wherein the configuration is received via radio resource control (RRC) signaling.

7. The method of claim 5, wherein the one or more L1 prediction triggers include one or more of time measurement values or radio measurement values.

8. The method of claim 5, wherein the procedure validity includes one or more of an inference periodicity, a moving window, or a one-time procedure.

9. The method of claim 1, wherein triggering the cell switch includes one or more of an early uplink (UL) synchronization, an early downlink (DL) synchronization, or triggering channel state information (CSI) measurement and reporting.

10. The method of claim 1, further comprising:
predicting one or more future L1 measurements for one or more cells in set of one or more LTM candidate cells, covering the prediction time span; and
transmitting a measurement report to a base station, wherein the report includes current L1 measurements and predicted L1 measurements for at least one cell in the set of one or more LTM candidate cells.

11. A wireless transmit/receive unit (WTRU) comprising:
a transceiver; and
a processor, operatively coupled to the transceiver; wherein:
the transceiver is configured to receive an indication indicating criteria for best target cell selection amongst more than one cell, wherein the criteria include: a current layer 1 (L1) measurement value criterion, at least one predicted L1 measurement value criterion, a prediction time span and a confidence level;
the processor is configured to determine a best target cell based on the criteria, and a determination of both a current L1 measurement value and at least one predicted L1 measurement value;
the transceiver and the processor are configured to trigger a cell switch to the determined best target cell, based on the determination of the best target cell; and
the transceiver and the processor are configured to transmit a feedback indication containing at least one of: a measured radio metric value at a time of the cell switch, and a predicted radio metric value at the end of the prediction time span.

12. (canceled)

13. The WTRU of claim 11, wherein the criteria further include one or more previously configured criteria.

14. The WTRU of claim 11, wherein the received indication is received via a medium access control (MAC) control element (CE).

15. The WTRU of claim 11, wherein the transceiver is further configured to receive a configuration with a set of one or more L1/layer 2 (L2) triggered mobility (LTM) candidate cells, wherein the configuration includes an associated predictive measurement configuration per candidate cell for one or more: one or more measurement metrics, one or more L1 prediction triggers, the prediction time span, procedure validity, or a reporting criterion.

16. The WTRU of claim 15, wherein the configuration is received via radio resource control (RRC) signaling.

17. The WTRU of claim 15, wherein the one or more L1 prediction triggers include one or more of time measurement values or radio measurement values.

18. The WTRU of claim 15, wherein the procedure validity includes one or more of an inference periodicity, a moving window, or a one-time procedure.

19. The WTRU of claim 11, wherein triggering the cell switch includes one or more of an early uplink (UL) synchronization, an early downlink (DL) synchronization, or triggering channel state information (CSI) measurement and reporting.

20. The WTRU of claim 11, wherein:
the processor is further configured to predict one or more future L1 measurements for one or more cells in set of one or more LTM candidate cells, covering the prediction time span; and
the transceiver and the processor are configured to transmit a measurement report to a base station, wherein the report includes current L1 measurements and predicted L1 measurements for at least one cell in the set of one or more LTM candidate cells.
